(19) United States
(12) Patent Application Publication
(10) Pub. No.: US 2014/0168984 A1
(43) Pub. Date: Jun. 19, 2014

(54) HARP MOUNTING SYSTEM

(71) Applicant: Michael O. Nevins, Jackson, MI (US)

(72) Inventor: Michael O. Nevins, Jackson, MI (US)

(21) Appl. No.: 14/029,055

(22) Filed: Sep. 17, 2013

Related U.S. Application Data
(60) Provisional application No. 61/702,515, filed on Sep. 18, 2012.

(51) Int. Cl. G10D 3/00; F21V 21/096; F21V 33/00

(52) U.S. Cl. CPC G10D 3/00; F21V 33/008; F21V 21/0965
USPC 362/253

(57) ABSTRACT

A harp mounting system is providing for creating a pathway between a ballast and an inductive light source in order to prevent phosphor burn on the light source. The harp mounting system has a harp elbow having a first end and a second end, a first harp block having an orifice adapted to receive the first end of the harp elbow therein, and a second harp block having an orifice adapted to receive the second end of the harp elbow therein. The first and second harp elbows are adapted to be secured to the light source and a fastener is provided to secure the harp elbow to at least one wire connecting a ballast to the inductive light source.

### BACKGROUND

Numerous approaches to providing illumination in darkened areas have been attempted. Typically, an electric current is provided to a lamp to cause a light bulb installed in the lamp to generate illumination, e.g., via a glowing filament, to a surrounding area. Other approaches have used a burning gas or other material to generate illumination to a surrounding area.

Induction fluorescent lamps offer the potential for increased life, decreased lumen depreciation (or improved lumen maintenance) and increased efficacy for lighting applications. Induction fluorescent lamp systems include the lamp having a phosphor coating, magnetic coupler and high frequency generator. Wires connecting the magnetic coupler to the high frequency generator are affixed directly to the lamp surface via adhesive tape. Over time, contact of the wires directly to the lamp surface causes phosphors to burn off the lamp surface. As such, lamp efficacy decreases. The tape used to affix the wire to the lamp surface also becomes brittle over time resulting in the wires coming loose from the lamp surface decreasing starting ability in cold temperatures.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a perspective view of an embodiment of a harp mounting system;

FIG. 2 is a top view of an embodiment of a harp mounting system;

FIG. 3 is a top view of the harp elbow of the harp mounting system;

FIG. 4a is a front view of the harp blocks of the harp mounting system;

FIG. 4b is a side view of the harp blocks of the harp mounting system;

FIG. 4c is a side view of the harp blocks of the harp mounting system

FIG. 5 is an elevated side view of an embodiment of a harp mounting system and a lighting system;

FIG. 6 is an elevated side view of an embodiment of a harp mounting system secured to a lighting system;

FIG. 7 is a top view of an embodiment of a harp mounting system secured to a lighting system and ballast;

FIG. 8 is a side view of an embodiment of a harp mounting system secured to a lighting system;

FIG. 9 is an exploded view of a shield connected to a magnetic coupler.

FIG. 10 is a perspective view of an embodiment of a harp mounting system;

FIG. 11 is a side view of the harp mounting system;

FIG. 12 is a side view of an embodiment of a harp mounting system secured to a lighting system;

FIG. 13a is an elevated perspective view of an embodiment of a harp mounting system, including a side shield;

FIG. 13b is an elevated perspective view of an embodiment of the shield; and

FIG. 14 is an elevated view of an embodiment of a harp mounting system secured to a lighting system.

### DETAILED DESCRIPTION

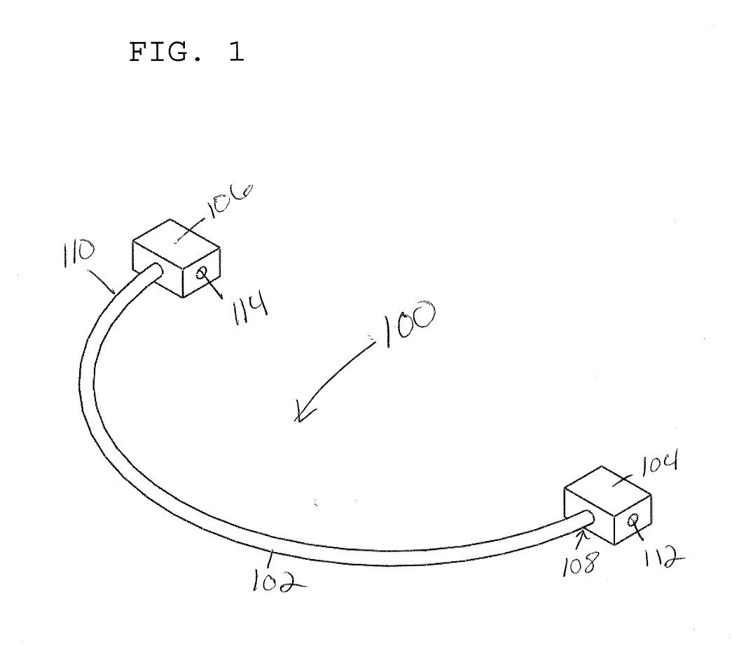

FIG. 1 depicts a perspective view of a harp mounting system 100 according to an embodiment of the present invention. Harp mounting system 100 comprises a harp elbow 102 and harp blocks 104 and 106.

In at least some embodiments, harp elbow 102 and harp blocks 104 and 106 are constructed of aluminum. In other embodiments, harp elbow 102 and harp blocks 104 and 106 are constructed of materials that are conductors of heat. In some other embodiments, harp elbow 102 is constructed of different materials from harp blocks 104 and 106.

Harp elbow 102 has opposing ends 110 and 108. Harp block 104 is positioned approximate end 108 and harp block 106 is positioned approximate end 110. In some embodiments, harp blocks 104 and 106 are positioned along the length of the harp elbow 102 and not at the opposite ends of the harp elbow 102.

Each harp block 104 and 106 have a through hole 112 and 114, respectively, which extend through the harp block and permit the harp mounting system 100 to be secured to a lighting system.

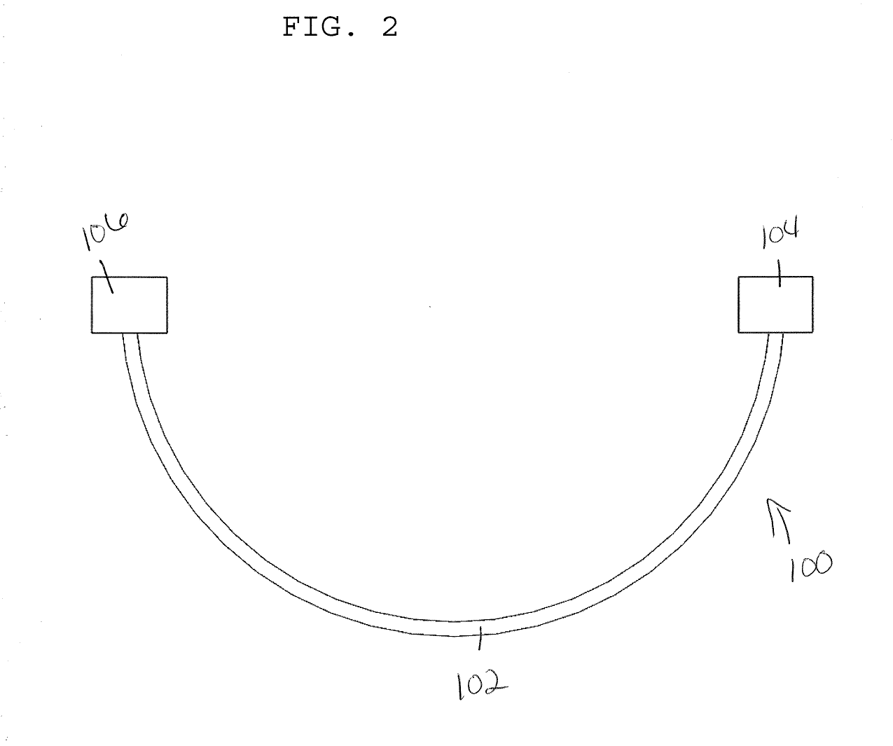

FIG. 2 depicts a top view of the harp mounting system 100. Harp elbow 102 is a rod formed into a semi-spherical shape. In some embodiments, the shape of the harp elbow 102 is conformed to match the general shape of at least a portion of an induction lamp. Harp elbow 102 is a rigid wire cable. In some embodiments, the harp elbow 102 is a hollow tube. In yet still other embodiments, harp elbow 102 is a solid wire form. In another embodiment, the harp elbow 102 is 360 degree circular wire form. In still further embodiments, the harp elbow 102 is a less than 360 degree circular wire form. Harp elbow 102 is rigidly formed to prevent bending or sagging of the harp elbow to prevent contact with the lamp.

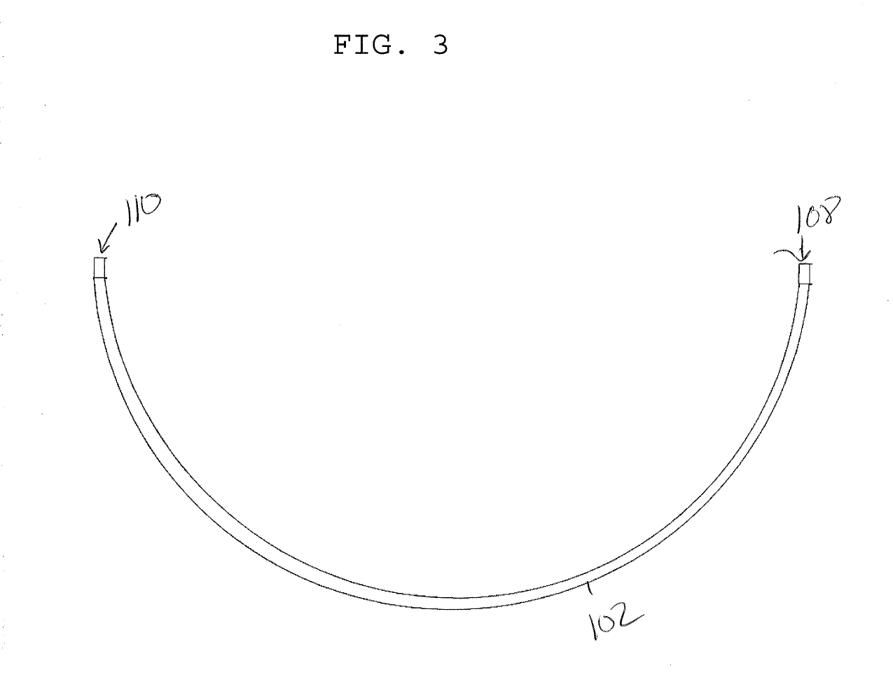

FIG. 3. depicts a top view of harp elbow 102. Harp elbow 102 has a first end 108 and a second end 110. The first end 108 and second end 110 are sized to be mated with harp blocks 104 and 106. The first end 108 is compression fit into an opening of the harp block 104, and the second end 110 is similarly compression fit into an opening of harp block 106. In some embodiments, first end 108 and second end 110 comprise a threaded connector, and harp blocks 104 and 106 are adapted to receive the threaded connector within a threaded opening. In some other embodiments, the first end 108 and second end 110 are welded, glued or adhered to the first end 104 and second end 106, respectively.

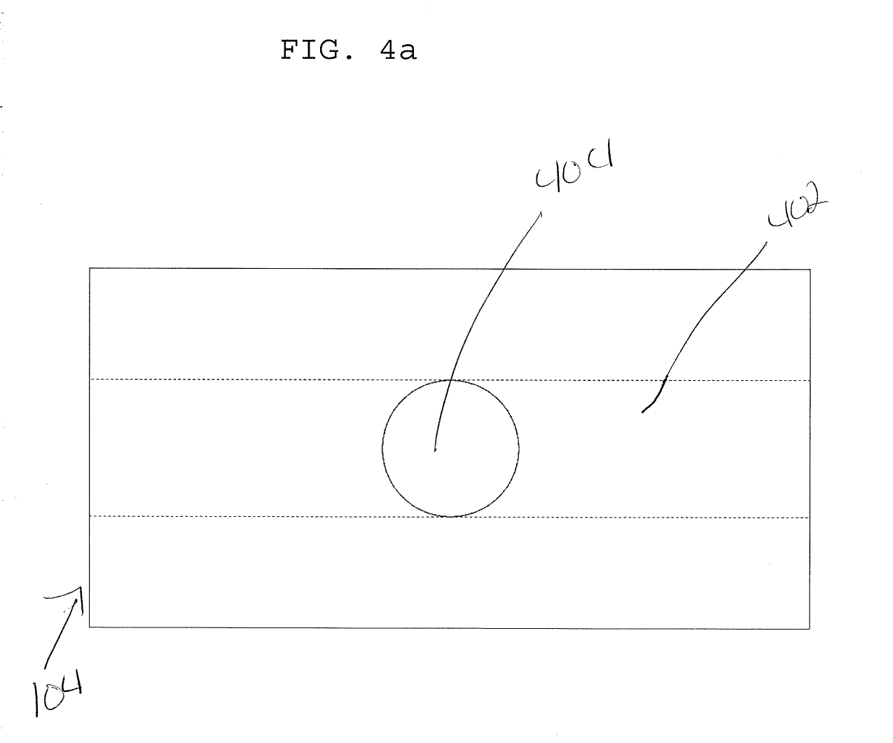

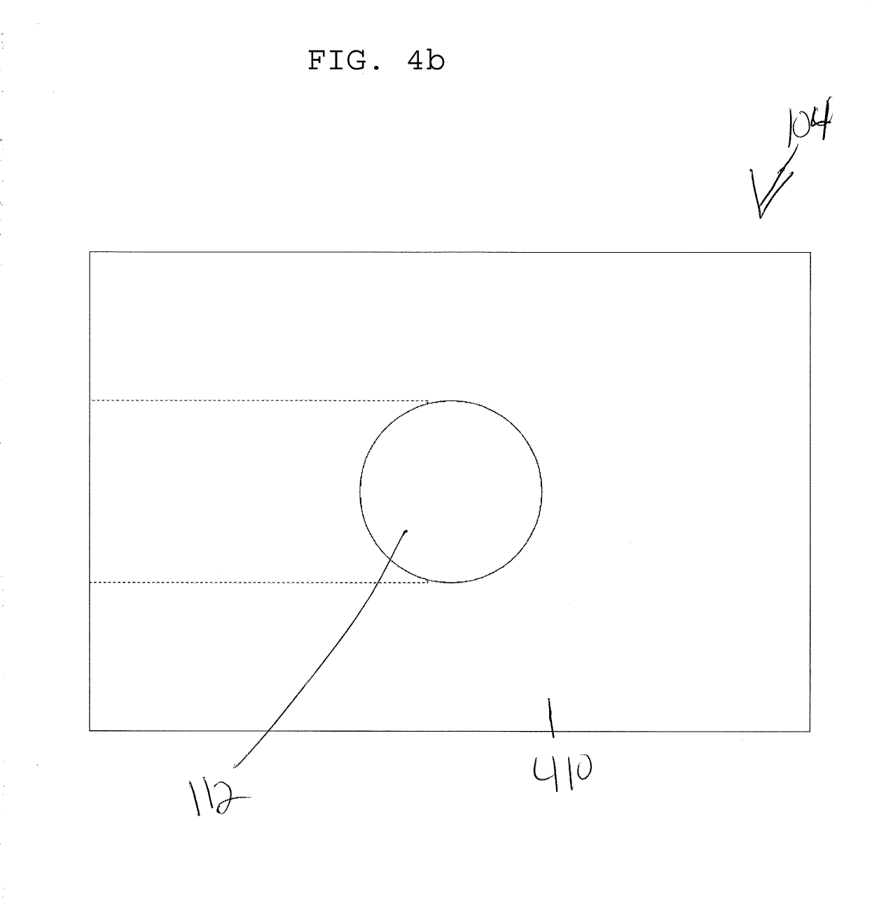

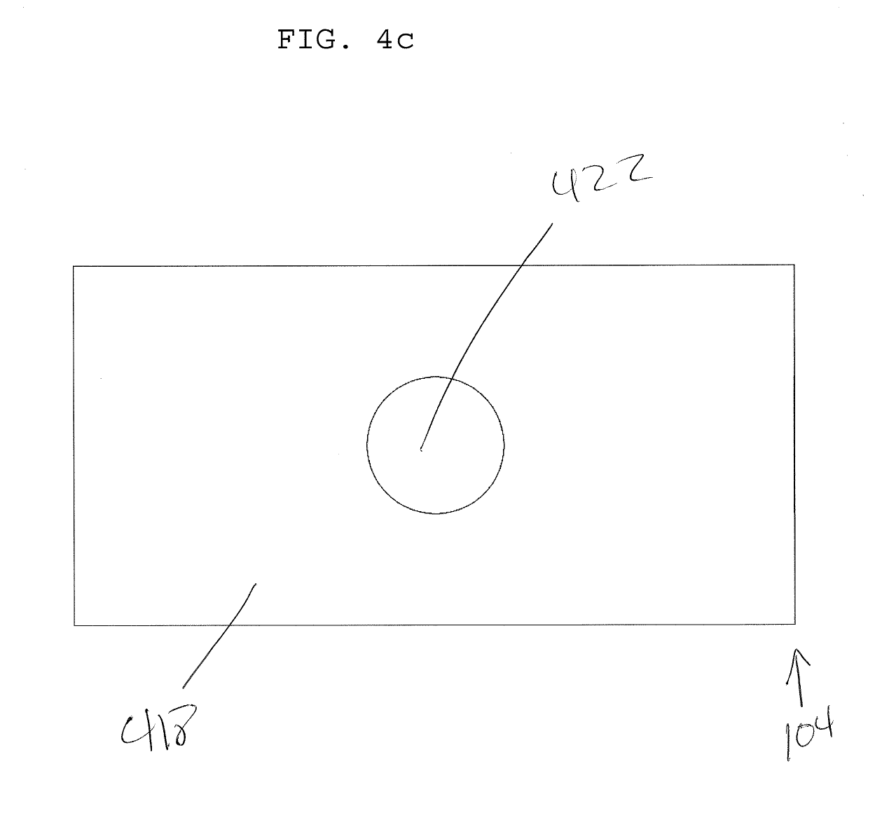

FIG. 4a depicts a front facing view of harp block 104. Harp block 104 is described herein. Harp block 106 is a mirror image of harp block 104. Harp block 104 is a parallelepiped having a front face 402. In some embodiments, harp block 104 is a sphere. In some embodiments, harp block 106 is a different shape from harp block 104.

Front face 402 is formed to define an orifice 404 near the center of the front face 402. In some embodiments, orifice 404 is formed off-set from center of the front face 402. Since the first end 108 is compression fit into the orifice 404, orifice 404 is sized to mate with the first end 108 of the harp elbow 102. In some embodiments, the size and shape of orifice 404 is altered to match the cross-sectional shape of the harp elbow 102. In some embodiments, orifice is formed with a threaded connector to mate with a first end 108 having an opposite threaded connector.

FIG. 4b depicts a side facing view of harp block 104. Harp block 104 has a face 410. Face 410 is formed to define a through hole 112. Through hole 112 is sized to allow the harp mounting system 100 to be affixed to a lighting system.

FIG. 4c depicts a reverse side facing view of harp block 104 from FIG. 4b. Harp block 104 has a face 418, which is a surface opposite to faces 410. Face 418 is each formed to define through holes 422. As such, through hole 422 communicates with through hole 112 to form a passageway through harp block 104 from face 410 to face 418.

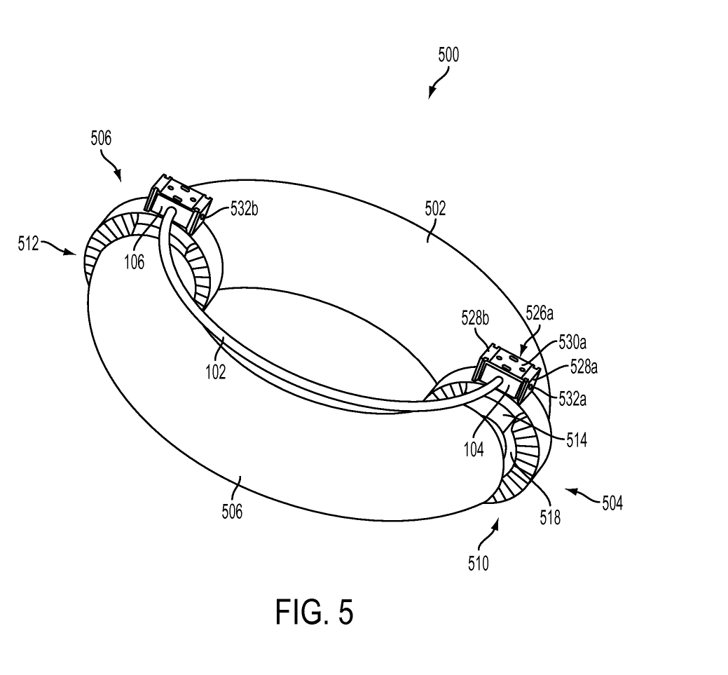

FIG. 5 depicts an elevated view of a harp mounting system 100 affixed to a lighting system 500. In the affixed arrangement, the harp elbow 102 is maintained at an elevated position relative to the surface of a light source 502 of the lighting system 500.

In at least some embodiments, light source 502 is an induction-based light source in order to provide increased lifespan and/or reduce a required initial energy requirement for illumination. In at least one embodiment, induction-based light source is a circular tube. In other embodiments, the light source is rectangular, square, oval, ellipsoid or other suitable shape.

In at least one embodiment, the light source 502 is a circular tube having at least two different diameters. The portion of the light source 502 having a smaller diameter defines a neck. In at least one embodiment, light source 502 has a pair of necks 510 and 512. Necks 510 and 512 are on opposite sides of the circumference of the light source. In some embodiments, the necks are unevenly positioned about the circumference of the light source.

Magnetic coupler assemblies 504 and 506 are each positioned around necks 510 and 512, respectively. The harp mounting system 100 is configured to be secured to existing magnetic coupler assemblies. Reference will be made to magnetic coupler assembly 504. Magnetic coupler assembly 506 is a mirror image of magnetic coupler assembly 504.

Magnetic coupler assembly 504 contains a ferrite inductor 518 about the outside of the light source 502 around neck 510. A coil 514 is wrapped around ferrite inductor 518, thereby creating an inductor.

Magnetic coupler assembly 504 comprises a mounting base 526a. Mounting base 526a has a pair of side walls 528a and 528b, and a cover 530a, which generally define an opening therein. Harp block 106 is sized to be fit within the opening formed by side walls 528a and 528b and cover 530a. Cover 530a has fittings adapted to secure the mounting base 526a to a light fixture. Side walls 528a and 528b each contain through holes 532a and 532b.

Light source 502 is made of glass and is filled with inert gas. In some embodiments, the light source 502 is made of transparent or translucent, high temperature polymer and is filled with an inert gas, such as Krypton and/or Argon. In yet other embodiments, the light source 502 is vacuum sealed. The inner surface of the light source 502 is coated with phosphors and comprises a mercury amalgam. The mercury amalgam provides mercury vapor inside the light source 502.

An induction-based light source does not use electrical connections through a lamp in order to transfer power to the lamp. Electrode-less lamps transfer power by means of electromagnetic fields in order to generate light. In an induction-based light source, an electronic ballast is connected to a power mains and generates an electric frequency that is used to transfer electric power to at least one coupler assembly.

In operation, high frequency energy is generated by the ballast and sent through wires to magnetic coupler assemblies 504 and 506. The inductor, once supplied with high frequency energy, creates a magnetic field, which travels through the light source 502 and excites mercury atoms in the interior of the light source 502. The excited mercury atoms emit UV light, which then excites phosphors coating the interior of the light source 502. The excited phosphors create illumination, including visible light.

Since induction-based lamps do not have components that can burn out, the induction lamps are rated at 100,000 hours, lasting longer than 100 incandescent, 5 HID, or 5 typical fluorescent lamp changes. In accordance with at least some embodiments, light source 502 may have an increased lifespan with respect to other types, e.g., incandescent and/or fluorescent light sources having electrodes. In accordance with at least some embodiments, light source 502 may have a reduced initial energy requirement for start up of the light source. In at least some embodiments, induction-based light source 502 is a 70 Watt induction lamp or a 100 Watt induction lamp. In other embodiments, the induction-based light source 502 is a 40-500 Watt induction lamp.

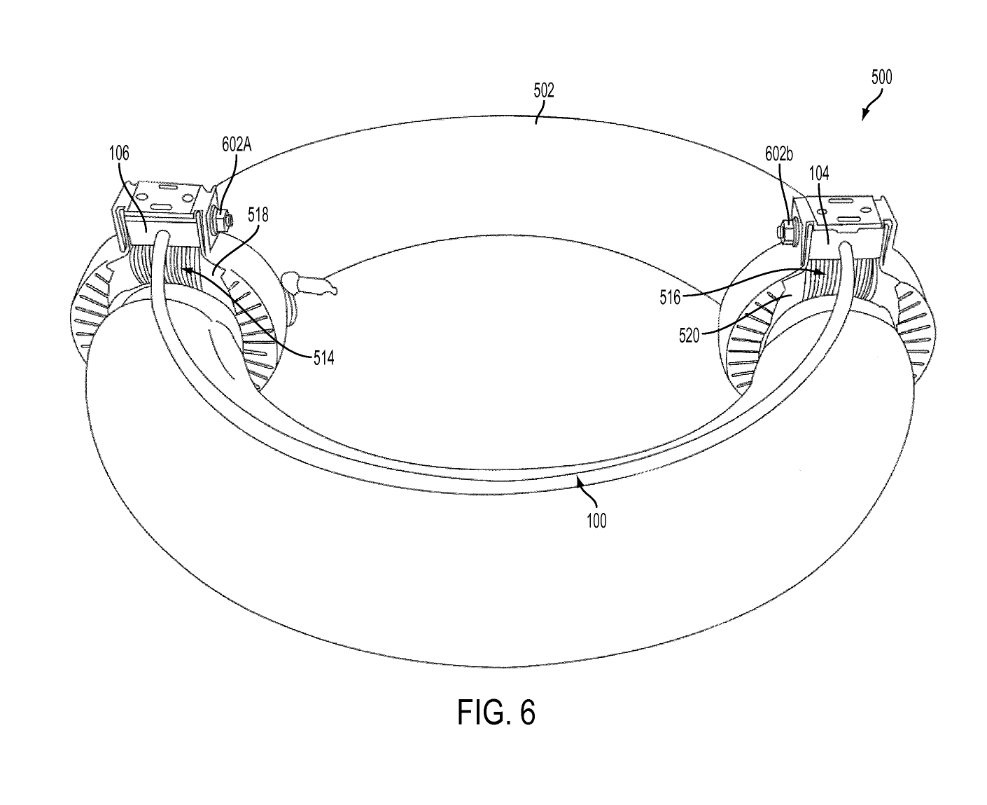

FIG. 6 is a side view of the lighting system 500, in which the harp mounting system 100 is affixed to the light source 502. With reference to harp block 104, retention assembly 602b is inserted into through hole 532a (FIG. 5) and 112 (FIG. 4b) and 422 (FIG. 4c). Similarly, retention assembly 602b is inserted into through hole 532b (FIG. 5) and the through holes of the harp block 106. As such, assemblies 602a and 602b secure the harp mounting system 100 to the light source 502. Retention assemblies 602a and 602b are threaded fittings. In some embodiments the retention assemblies are nut and bolt assemblies. In some embodiments, assemblies are snap fittings or compression fittings.

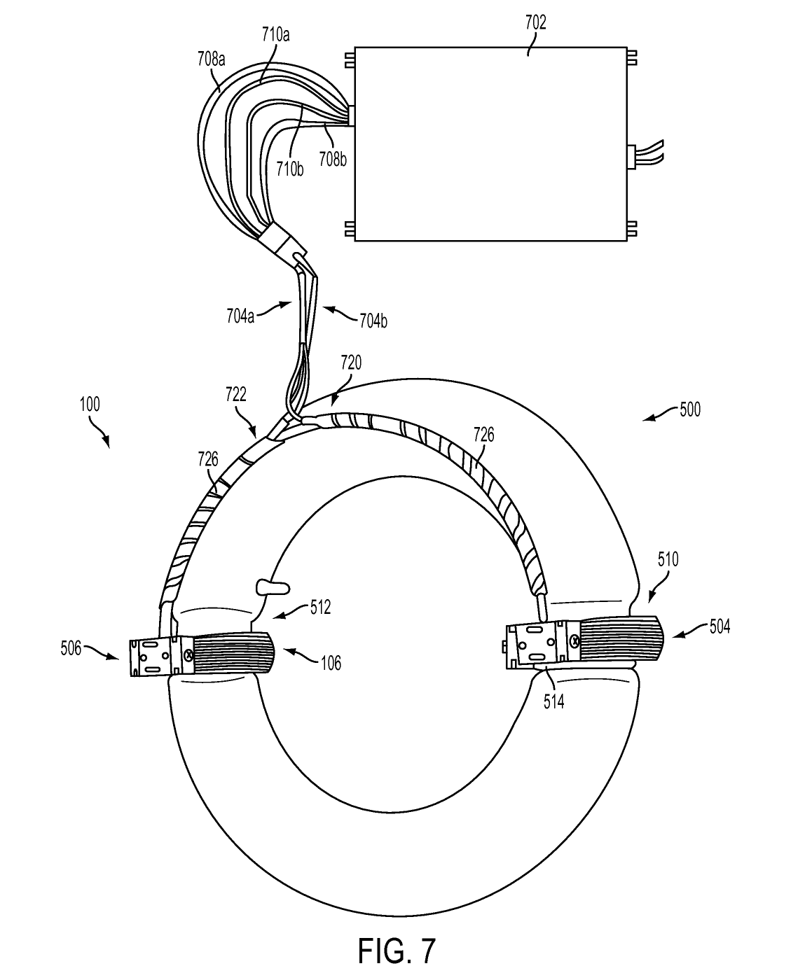

FIG. 7 is a top view of the harp mounting system 100 affixed to a lighting system 500. Ballast 702 is connected to wires 704a and 704b. Wires 704a and 704b are copper wires. In some embodiments, wires 704a and 704b are aluminum wires.

The ballast 702 generates high frequency energy, which is sent through wires 704a and 704b. Wire 704a has a first end 708a and a second end 708b, and wire 704b has a first end 710a and a second end 710b. The ballast 702 has a cathode that connects to the first ends 708a and 710a. The ballast 702 supplies high frequency energy from first ends 708a and 710a, through wires 704a and 704b, to the second ends 708b and 710b, and returns to the ballast 702 via an anode.

Wire 704a is connected to magnetic coupler assembly 506 and wire 704b is connected to magnetic coupler assembly 504. Since the connection of wire 704a to magnetic coupler assembly 506 is the same, the connection of wire 704b to magnetic coupler assembly 504 will be described herein. In some other embodiments, the connections are different.

Wire 704b is wrapped around the ferrite inductor 518 of magnetic coupler assembly 504 to integrally form coil 514 (FIG. 6). As such, wires 704a and 704b are integrally formed as part of the coils 514 and 516 of the magnetic coupler assemblies 504 and 506. Once activated, ballast 702 supplies high frequency energy to the coils 514 and 516, thereby creating an inductor and magnetic field thereby causing the light source 502 to generate illumination.

In some other embodiments, wire 704b and coil 514 are separately formed and connected via soldering or other conventional manner to affix two cables.

In at least one embodiment, wires 704a and 704b are positioned within conduits 720 and 722, respectively. Conduits 720 and 722 are affixed to the harp elbow 102 via a fastener 726. In at least one embodiment, the fastener is an adhesive tape. In other embodiments, the fastener is a spiral wire loom, solid wire loom, clamp or cable ties. In still yet other embodiments, the fastener is a sleeve that also provides protection from heat. In some embodiments, the sleeve is a flexible polytetrafluoroethylene cloth that protects wires 704a and 704b from high sources of heat. In at least some embodiments, the sleeve is larger in diameter than the wires that are placed inside, which also provides some protection from heat.

In other embodiments, harp elbow 102 is formed to include conduits 720 and 720 therein. As such, additional fastening means are not required. In other embodiments, wires 704a and 704b are fastened directly to the harp elbow 102 without the use of a conduit.

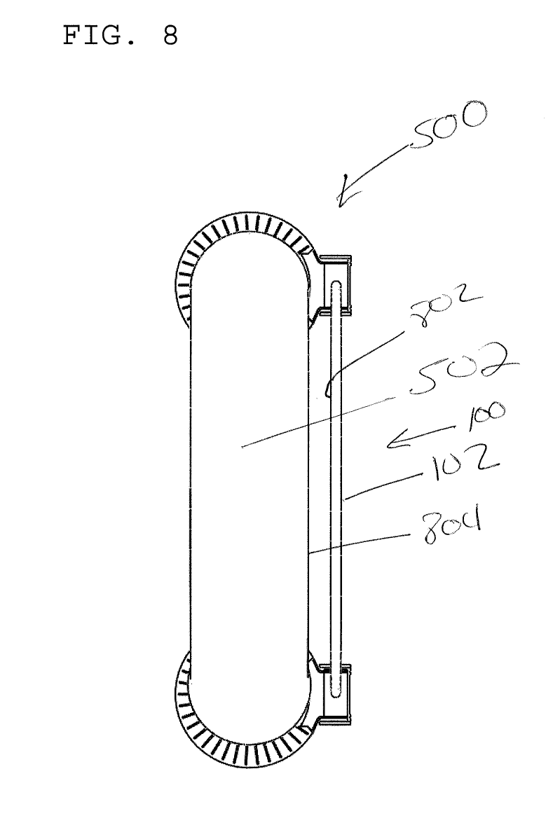

FIG. 8 is a side view of the harp mounting system 100 affixed to a lighting system 500. A surface 802 of harp elbow 102 is spaced a distance X from a surface 804 of light source 502. As such, fastening of the wires 704a and 704b to the elevated harp elbow 102 prevents contact of the wires 704a and 704b with the surface of the light source 502, thereby preventing phosphor burn within the light source 502.

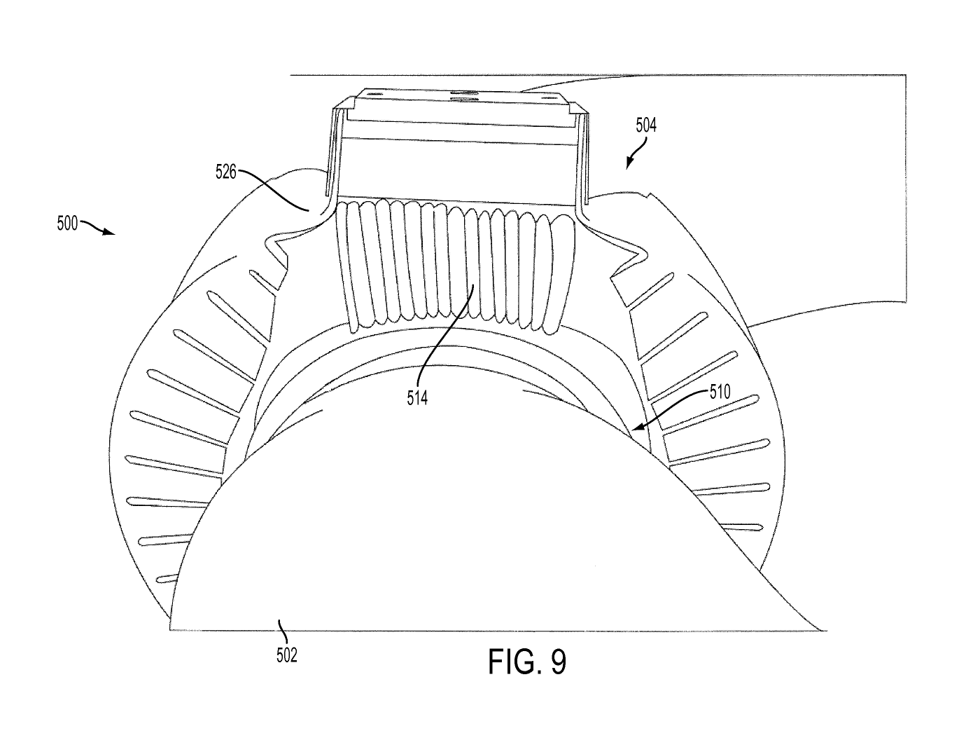

FIG. 9 is an expanded view of magnetic coupler 504 about neck 510 of light source 502. In some other embodiments, affixed to mount 526a is a shield which covers coil 514. In this style the mount 526a and shield are integrally formed as one piece. In at least one embodiment, shield is made of aluminum. In other embodiments, shield is made of other heat conductors. In some other embodiments, shield is separately formed from the mount 526a and it is configured to snap around the lamp neck 510 and held in place via friction. In some other embodiments, the shield is integrally formed as part of the magnetic coupler 504. In some other embodiments, shield is formed in a U shape that slides over the ferrite inductor 518 and underneath the magnetic coupler 504.

A shield aids in keeping the two ferrite core halves together and prevents sheering apart and also helps to contain the magnetic field and reduce the likelihood of said field causing interference with other devices. In at least some embodiments, shield is an optional component.

As described above, the harp mounting system 100 is capable of being retrofit onto existing magnetic coupler assemblies 504 and 506 of a lighting system 500.

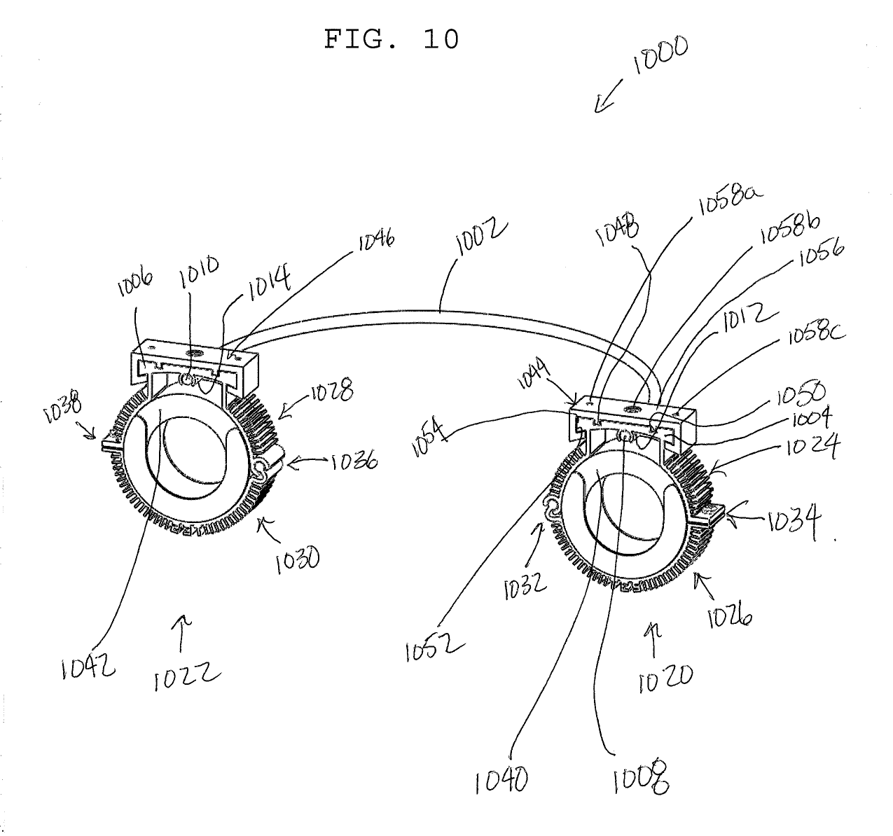

In another embodiment, the harp mounting system is integrally formed with magnetic coupler assemblies as shown in FIGS. 10-14.

FIG. 10 depicts a perspective view of a harp mounting system 1000. Harp mounting system 1000 comprises a harp elbow 1002 and harp blocks 1004 and 1006. Harp elbow 1002 has opposing ends 1010 and 1008. Harp block 1004 is positioned approximate end 1008 and harp block 1006 is positioned approximate end 1010.

Harp blocks 1004 and 1006 have corresponding clips 1012 and 1014. Clips 1012 and 1014 are formed to reliably secure ends 1008 and 1010 by friction fitting. In other embodiments, alternate connecting methods are usable. As such, the harp elbow 1002 is secured to the harp blocks 1004 and 1006.

Harp blocks 1004 and 1006 are each integrally formed as part of magnetic couplers 1020 and 1022, respectively. Harp block 1004 is molded integrally with a first portion 1024 of the magnetic coupler 1020. First portion 1024 is releasably attached to second portion 1026 by hinge arrangement 1032 and fastener arrangement 1034.

Harp block 1006 is molded integrally with a first portion 1028 of the magnetic coupler 1022. First portion 1028 is releasably attached to second portion 1030 by hinge arrangement 1036 and fastener arrangement 1038.

Magnetic coupler assemblies 1020 and 1022 each contain a ferrite inductor 1040 and 1042, respectively. As described above, a ferrite inductor wraps around the outside of the neck 510 of a light source 502, and a coil 514 may be wrapped around ferrite inductor 1040, thereby creating an inductor.

Magnetic coupler assemblies 1020 and 1022 each comprise a mounting base 1044 and 1046, respectively. Mounting base 1044 will be described herein, but it should be understood that mounting base 1046 has identical features. Mounting base 1044 has an interior surface 1052 that is a mirror image of the exterior surface 1054 of harp block 1004. Additionally, mounting base 1044 and harp block 1004 have matable friction fittings 1048 and 1050 that permit the mounting base to be releasably secured to the harp block. In this manner, the mounting base 1044 is secured to the magnetic coupler assembly.

Mounting base 1044 also has a top surface 1056, which generally defines openings therein 1058a, 1058b and 1058c. Openings 1058a, 1058b and 1058c are matable with fasteners to secure the mounting base 1044 to a light fixture.

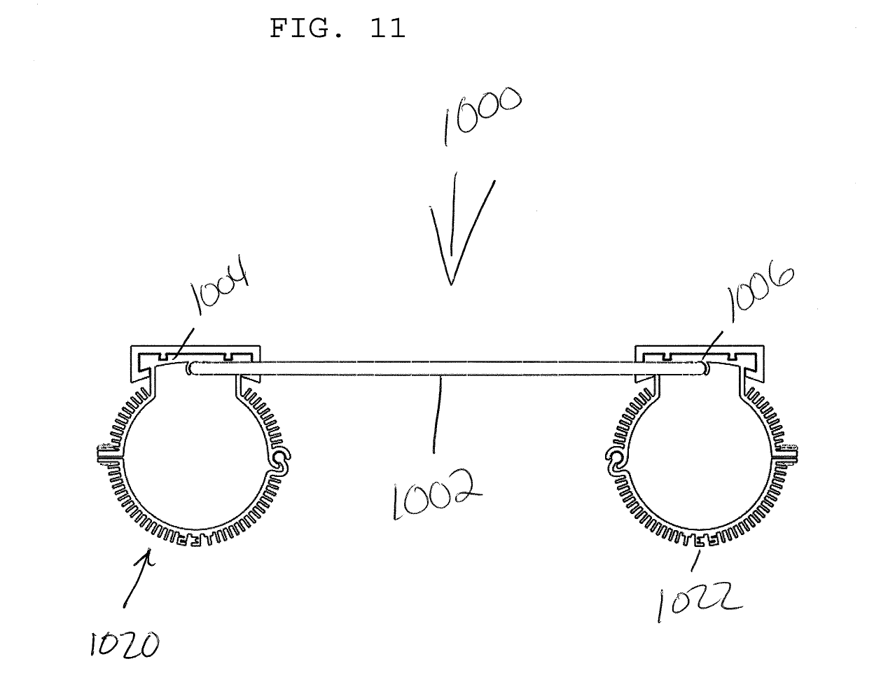

FIG. 11 is a side view of the harp mounting system 1000.

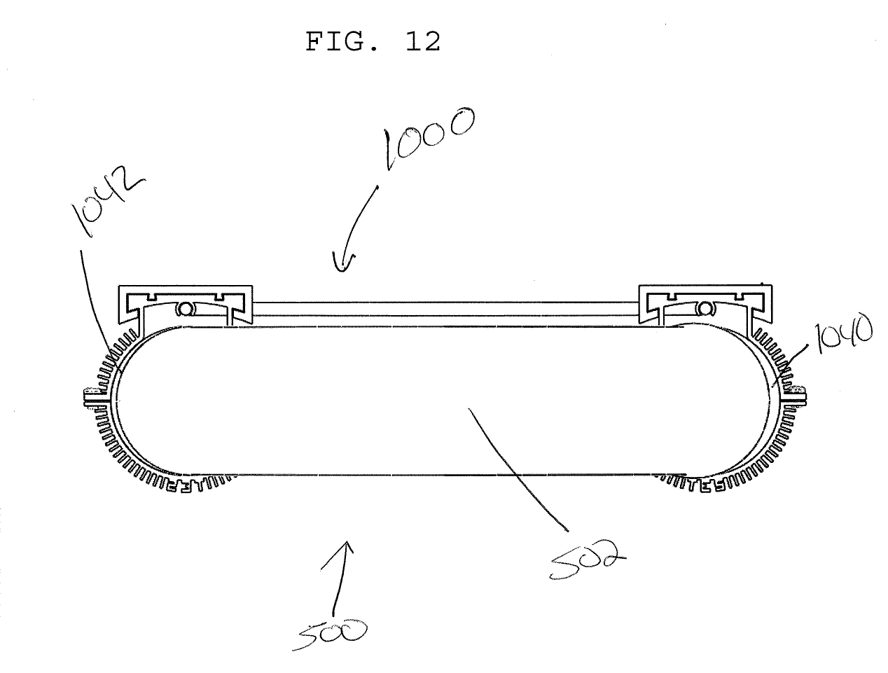

FIG. 12 is a side view of an embodiment of a harp mounting system 1000 secured to a lighting system 500. As shown, ferrite inductors 1040 and 1042 wrap around the outside of the light source 502

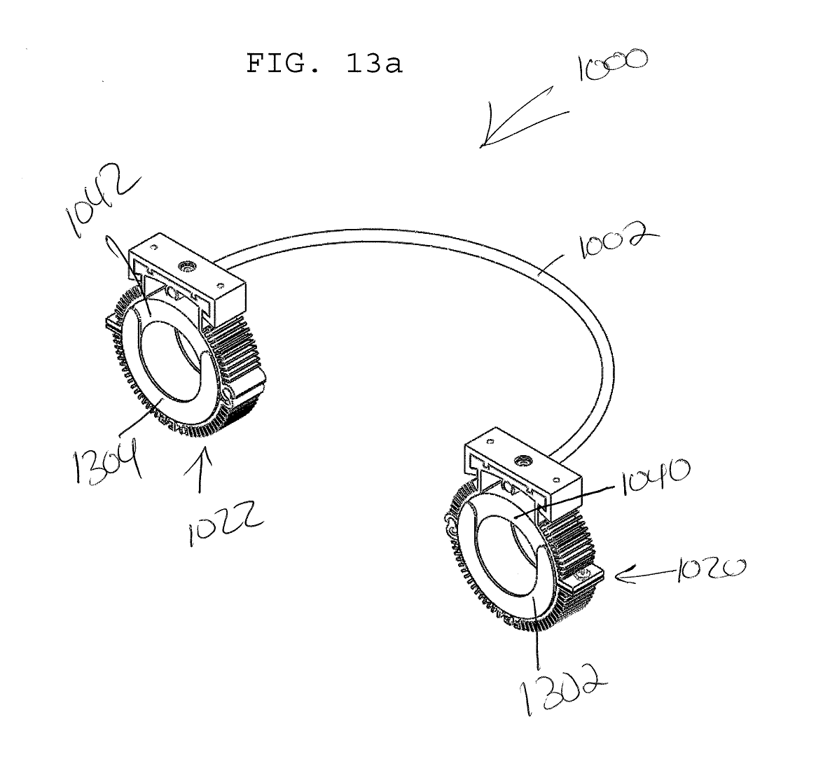

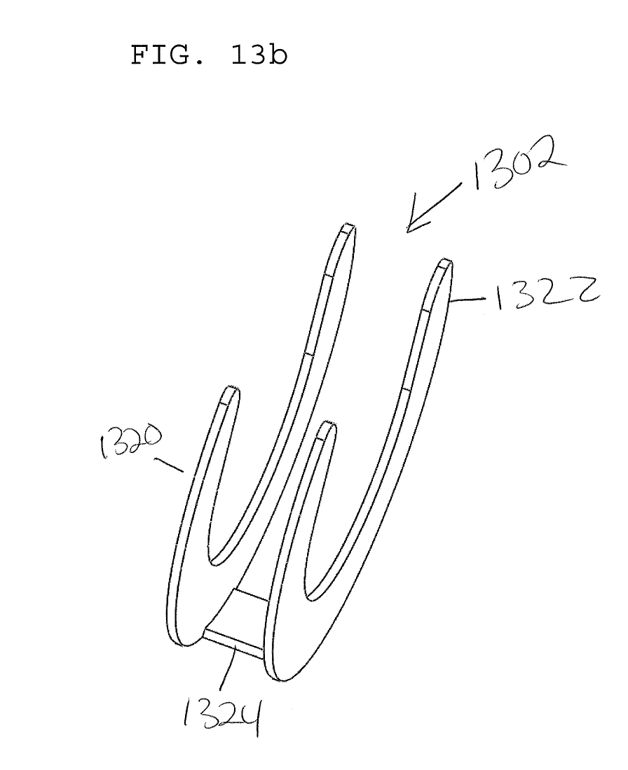

FIG. 13a is an elevated perspective view of an embodiment of a harp mounting system 1000. As shown, a shield 1302 is affixed to magnetic coupler assembly 1020. Similarly, a shield 1304 is affixed to magnetic coupler assembly 1022.

Shield 1302 will be described herein, but it should be understood that shield 1304 has identical features. Shield 1302 is formed in a U shape that partially surrounds the ferrite inductor 1040. Shield 1302 slides over and/or under a bottom portion of the ferrite inductor 1040. Shield 1302 also is fitted between the ferrite inductor 1040 and the magnetic coupler assembly 1020. In this manner, shield 1302 aids in keeping halves of the ferrite inductors 1040 together and prevents sheering apart and also helps to contain the magnetic field and reduce the likelihood of said field causing interference with other devices.

FIG. 13b is an elevated perspective view of an embodiment of the shield 1302. In at least one embodiment, shield 1302 has a pair of U shaped elements 1322 that are mirror images of each other. In other embodiments, elements 1322 are differently shaped. Elements 1320 and 1322 are connected by a post 1324. Post 1324 is shaped to fit between an outer portion of the ferrite conductor 1040 and inner portion of the magnetic coupler assembly 1020.

In some other embodiments, shield 1302 has a pair of posts 1324, the first post sized to fit over an inner portion of the ferrite conductor 1040 and the second post sized to fit under an outer portion of the ferrite conductor.

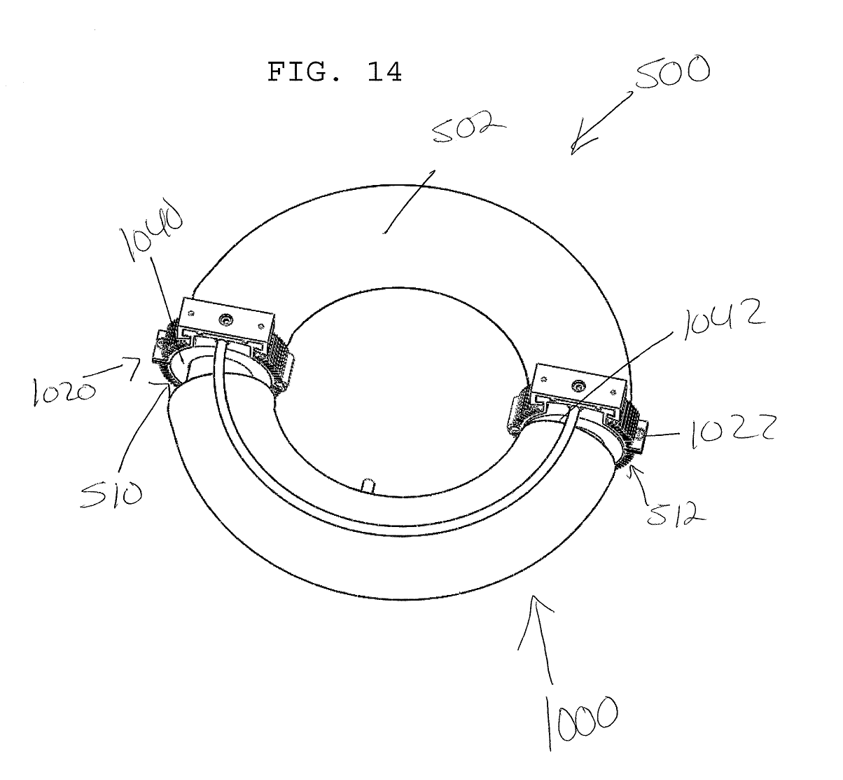

FIG. 14 is an elevated view of an embodiment of a harp mounting system 1000 secured to a lighting system 500. As shown, ferrite inductors 1040 and 1042 wrap around the corresponding necks 510 and 512 of the light source 502.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A harp mounting system, comprising:
a harp elbow having at least one end;
at least one harp block having an orifice adapted to receive the end of the harp elbow therein;
the at least one harp block adapted to be secured to a magnetic coupler assembly of an inductive light source; and
the harp elbow defining a pathway for routing a wire from a ballast to the magnetic coupler.

2. The harp mount system of claim 1, wherein the at least one harp block is integrally formed with the magnetic coupler assembly.

3. The harp mount system of claim 1, wherein the at least one harp block is releasably secured to the magnetic coupler assembly.

4. The harp mounting system of claim 1, wherein the harp elbow comprises a conduit adapted to receive therein the at least one wire connecting the ballast to the inductive light source.

5. The harp mounting system of claim 4, wherein a fastener affixes the conduit to the harp elbow.

6. The harp mounting system of claim 1, wherein the harp elbow is made of aluminum.

7. The harp mounting system of claim 1, wherein the at least one harp block is made of aluminum.

8. The harp mounting system of claim 1, wherein the harp elbow is a semicircular rod.

9. The harp mounting system of claim 8, wherein the harp elbow is rigidly formed to prevent bending or sagging of the harp elbow.

10. A harp mounting system, comprising:
a means for providing a pathway between a ballast and an inductive light source;
a means for elevating the pathway relative to the surface of the inductive light source; and
a means for securing to the pathway at least one wire connecting a ballast to the inductive light source.

11. The harp mounting system of claim 10, further comprising a means for receiving therein the at least one wire connecting the ballast to the inductive light source.

12. The harp mounting system of claim 10, wherein the means for providing a pathway between a ballast and an inductive light source comprises a semicircular rod.

13. The harp mounting system of claim 12, wherein the semicircular rod is made of aluminum.

14. The harp mounting system of claim 12, wherein the semicircular rod is rigidly formed to prevent substantial bending or sagging.

15. The harp mounting system of claim 10, wherein the means for elevating the pathway relative to the surface of the inductive light source comprises a pair of blocks connecting the means for providing a pathway to the inductive light source.

16. The harp mounting system of claim 15, wherein the pair of blocks are made of aluminum.

17. A system for routing wire to an inductive light source, comprising:
a harp mounting system, comprising
a harp elbow;
at least one harp block having an orifice adapted to receive an end of the harp elbow therein;
a light fixture, comprising
an inductive light source having at least one neck;
at least one magnetic coupler positioned about the at least one neck, the at least one magnetic coupler comprising a mount, the at least one harp block secured to the at least one mount; and
the harp elbow elevated from a surface of the light source and defining a pathway for routing a wire to the at least one magnetic coupler.

18. The harp mounting system of claim 17, wherein the harp mounting system further comprises a conduit adapted to receive therein the at least one wire connecting the ballast to the inductive light source.

19. The harp mounting system of claim 18, wherein the fastener affixes the conduit to the harp elbow.

20. The harp mounting system of claim 17, wherein the harp elbow is made of aluminum.

21. The harp mounting system of claim 17, wherein the at least one harp block is made of aluminum.

22. The harp mounting system of claim 17, wherein harp elbow is a semicircular rod rigidly formed to prevent substantial bending or sagging of the harp elbow.
